(19) United States
(12) Patent Application Publication
(10) Pub. No.: US 2011/0106379 A1
(43) Pub. Date: May 5, 2011

(54) In-vehicle system

(75) Inventors: Masahiro Fujii, Obu-city (JP); Kyoji Oda, Gamagori-city (JP); Kenji Miyake, Anjo-city (JP)

(73) Assignee: DENSO CORPORATION, Kariya-city (JP)

(21) Appl. No.: 12/923,044

(22) Filed: Aug. 31, 2010

(30) Foreign Application Priority Data
Oct. 30, 2009 (JP) 2009-250435

(51) Int. Cl. G06F 19/00; G01C 21/00

(52) U.S. Cl. 701/36

(57) ABSTRACT

An in-vehicle system is disclosed. The in-vehicle system includes a display unit, a navigation apparatus storing therein a first flash player, and an in-vehicle apparatus storing therein a second flash player. The navigation apparatus and the in-vehicle apparatus are provided separately from each other. The first flash player and the second flash player are respectively operable to play back display data so that the display unit displays a display screen made by the play back. The navigation apparatus and the in-vehicle apparatus can respectively perform a process of starting the first flash player and a process of starting the second flash player, independently of each other.

### CROSS REFERENCE TO RELATED APPLICATION

The present application is based on Japanese Patent Application No. 2009-250435 filed on Oct. 30, 2009, disclosure of which is incorporated herein by reference.

### BACKGROUND OF THE INVENTION

1. Field of the Invention

The present invention relates to an in-vehicle system including a navigation apparatus and an in-vehicle apparatus which are mounted to a vehicle.

2. Description of Related Art

Japanese Unexamined Patent Application Publication No. 2009-146278 discloses an information processing device having a flash player, which is a program for playing back a swf file made with Flash (registered trademark) of Adobe Co., Ltd.

A navigation apparatus having a flash player is becoming popular in accordance with the development of GUI (Graphical User Interface) technology for an in-vehicle apparatus. The inventors of the present application have studied an in-vehicle system including a navigation apparatus and an in-vehicle apparatus that are provided separately from each other, and that cooperate with each other to provide various services to a user. The inventors of the present application have found that if the flash player is installed in only the navigation apparatus, it is conceivable that various difficulties arise. Examples of various conceivable difficulties will be described below.

When it is assumed that a display device is shared by the navigation apparatus and the in-vehicle apparatus, the flash player installed in the navigation apparatus is shared by the navigation apparatus and the in-vehicle apparatus. In this case, it is conceivable that display cannot be properly switched between the navigation apparatus and the in-vehicle apparatus.

When a flash player is improved (what is called version-up) due to, for example, function addition, bug fix or the like, it is common to update the flash player. In the case of a navigation apparatus however, since stabile operation of navigation functions (e.g., route retrieval, rout guidance etc.) is typically put ahead of the update of a flash player, a user tends to hesitate to update the flash player, and it is conceivable that functions as the in-vehicle system cannot be enhanced.

### SUMMARY OF THE INVENTION

In view of the foregoing, it is an objective of the present invention to provide an in-vehicle system that includes a navigation apparatus and an in-vehicle apparatus configured to cooperate with each other, and that can solve various conceivable difficulties that may arise if a flash player is installed in only the navigation apparatus.

According to an aspect of the present invention, an in-vehicle system is provided. The in-vehicle system includes a display unit, a navigation apparatus, and a in-vehicle apparatus. The navigation apparatus includes: a first storage unit storing therein a first flash player; and a first controller configured to (i) start the first flash player stored in the first storage unit, (ii) cause the first flash player to play back first display data, and (iii) cause the display unit to display a display screen that is made by the first flash player playing back the first display data. The in-vehicle apparatus is provided separately from the navigation apparatus, and includes: a second storage unit storing therein a second flash player; and a second controller configured to (i) start the second flash player stored in the second storage unit, (ii) cause the second flash player to play back second display data, and (iii) cause the display unit to display a display screen that is made by the second flash player playing back the second display data. The first controller and the second controller are further configured to be operable such that: the first controller performs a process of starting the first flash player independently of a process of starting the second flash player by the second controller; and the second controller performs the process of starting the second flash player independently of the process of starting the first flash player by the first controller.

According to the above in-vehicle system, the flash player is installed in not only the navigation apparatus. The flash players are respectively installed in both of the navigation apparatus and the in-vehicle apparatus. Therefore, the in-vehicle system can solve the various conceivable difficulties that could arise if the flash player were installed in only the navigation apparatus.

### BRIEF DESCRIPTION OF THE DRAWINGS

The above and other objects, features and advantages of the present invention will become more apparent from the following detailed description made with reference to the accompanying drawings. In the drawings:

FIG. 1 is a functional block diagram illustrating an in-vehicle system according to one embodiment;

FIG. 2 is a flowchart illustrating processes performed by a navigation apparatus; and

FIG. 3 is a flowchart illustrating processes performed by an in-vehicle apparatus.

### DETAILED DESCRIPTION OF EMBODIMENTS

Embodiments will be described below with reference to the accompanying drawings.

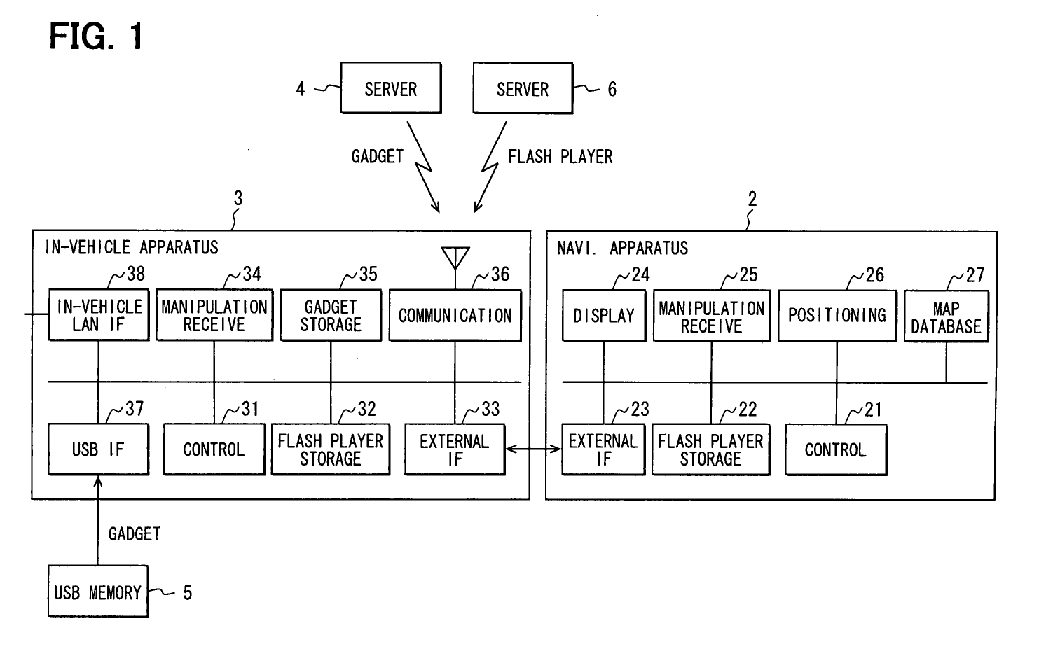

FIG. 1 is a functional block diagram illustrating an in-vehicle system 1. The in-vehicle system 1 includes a navigation apparatus 2 and an in-vehicle apparatus 3 which are mounted to a vehicle. The navigation apparatus 2 includes a controller 21, a flash player storage unit 22, an external interface (IF) unit 23, a display unit 24, a manipulation reception unit 25, a present location identification unit 26, and a map database 27. The foregoing components of the navigation apparatus 2 are connected with each other.

The controller 21 includes a central processing unit (CPU), a random access memory (RAM), a read-only memory (ROM) and the like. The controller 21 executes a control program thereby to control generally all of operations (e.g., a data management operation, a communication operation etc.) of the navigation apparatus 2. The flash player storage unit 22 stores therein a flash player, which is a program for playing back a swf file made with Flash (registered trademark) of Adobe Co., Ltd. The external interface 23 transfers data to the in-vehicle apparatus 3 and receives data from the in-vehicle apparatus 3, which is an external apparatus of the navigation apparatus 2, i.e., which is external with respect to the navigation apparatus 2.

The display unit 24 includes, for example, a liquid crystal display device. When receiving a display command signal from the controller 21, the display unit 24 displays a display screen that is based on the display command signal. The manipulation reception unit 25 includes, for example, a touch sensitive switch or the like. The touch sensitive switch is provided on the display screen, which is displayed on the display unit 24. In response to user manipulation (e.g., touch) on the touch sensitive switch, the manipulation reception unit 25 outputs a manipulation detection signal, which indicates content of the user manipulation, to the controller 21. The present location identification unit 26 includes a GPS (global positioning system) receiver for receiving a GPS signal from GPS satellites, an acceleration sensor for detecting acceleration, a distance sensor for detecting traveling distance, and the like. The present location identification unit 26 performs calculation based on parameters extracted from the GPS signal. The present location identification unit 26 complements a result of the calculation and results of detection of various sensors with each other, thereby identifying the present location of the vehicle.

The controller 21 of the navigation apparatus 2 starts the flash player stored in the flash player storage unit 22, and causes the flash player to play back display data. The controller 21 causes the display unit 24 to display the display screen that is made by the flash player playing back the display data. To provide a navigation function, the controller 21 can perform the following processes. The controller 21 causes the display unit 24 to display a map corresponding to map data stored in the map database 27. On the map, the controller 21 superimposes a present location mark indicative of the present location of the vehicle identified by the present location identification unit 26. When a user manipulates the manipulation reception unit 25 to set a destination, the controller 21 retrieves a route from the present location to the destination and performs route guidance. The navigation apparatus 2 may be in an operating state (i.e., powered-on state) when ACC switch (accessory switch or ignition switch) is in ON. The navigation apparatus 2 may be in a stopped state (i.e., powered-off state) when the ACC switch is in OFF.

The in-vehicle apparatus 3 includes a controller 31, a flash player storage unit 32, an external interface 33, a manipulation reception unit 34, a gadget storage unit 35, a communication unit 36, a USB interface unit 37, and an in-vehicle LAN interface unit 38. The above components are connected with each other.

The controller 31 includes a CPU, a RAM, a ROM and the like, and executes a control program to thereby control generally all of operations (e.g., data management operation, communication operation) of the in-vehicle apparatus 3. The flash player storage unit 32 stores therein a flash player, which is a program for playing back a swf file made with Flash of Adobe Co., Ltd. The external interface 33 transfers data to the navigation apparatus 2 and receives data from the navigation apparatus 2, which is an external apparatus of the in-vehicle apparatus 3, that is, which is external with respect to the in-vehicle apparatus 3. The manipulation reception unit 34 includes a mechanical switch (hard switch, which is mechanical one) and the like. In response to user manipulation on the mechanical switch and the like, the manipulation reception unit 34 outputs a manipulation detection signal, which indicates contents of the user manipulation, to the controller 31. The manipulation reception unit 34 and the above-described manipulation reception unit 25 may share the display unit 24 of the navigation apparatus 2, and the manipulation reception unit 34 may include a touch sensitive switch provided on the display screen, which is displayed on the display unit 24.

The gadget storage unit 35 can store therein a gadget, which the communication unit 36 may receive from a server 4 via a wide area wireless communication link such as a mobile communication link, a fixed communication link and the like. Alternatively, the gadget may be transferred to the USB interface unit 37 from a USB memory 5, which is detachably connectable to the in-vehicle apparatus 3. In the above, the gadget is a relatively-small program (software) for enabling easy access to a tool that is frequently used by a user. The gadget is also called widget. Via a wide area wireless communication link, the communication unit 36 can receive a flash player transmitted from a server 6.

The controller 31 of the in-vehicle apparatus 3 starts the flash player stored in the flash player storage unit 32, and causes the flash player to play back display data. The controller 31 transfers the display screen, which is made by the flash player playing back the display data, to the navigation apparatus 2 via the external interface 33, thereby causing the display unit 24 to display the display screen made by the flash player playing back the display data. The in-vehicle apparatus 3 is, for example, in an operating state (i.e., powered-on state) when ACC switch (accessory switch or ignition switch) is in ON. The in-vehicle apparatus 3 may be in a stopped state (i.e., powered-off state) when the ACC switch is in OFF.

The in-vehicle system 1 is configured in the following way. The navigation apparatus 2 and the in-vehicle apparatus 3 share the display unit 24. The controller 21 of the navigation apparatus 2 can perform a process of starting the flash player stored in the flash player storage unit 22 independently of a process of starting the flash player stored in the flash player storage unit 32 by the controller 31 of the in-vehicle apparatus 3. The controller 31 of the in-vehicle apparatus 3 can perform the process of starting the flash player stored in the flash player storage unit 32 independently of the process of starting the flash player stored in the flash player storage unit 32 by the controller 21 of the navigation apparatus 2.

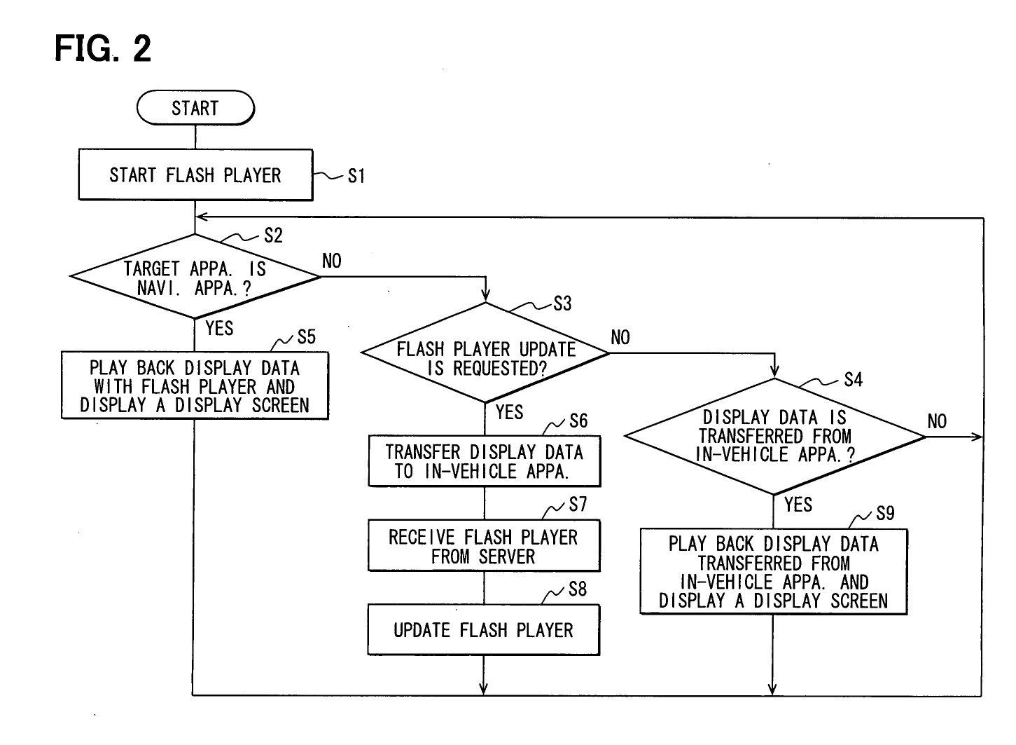

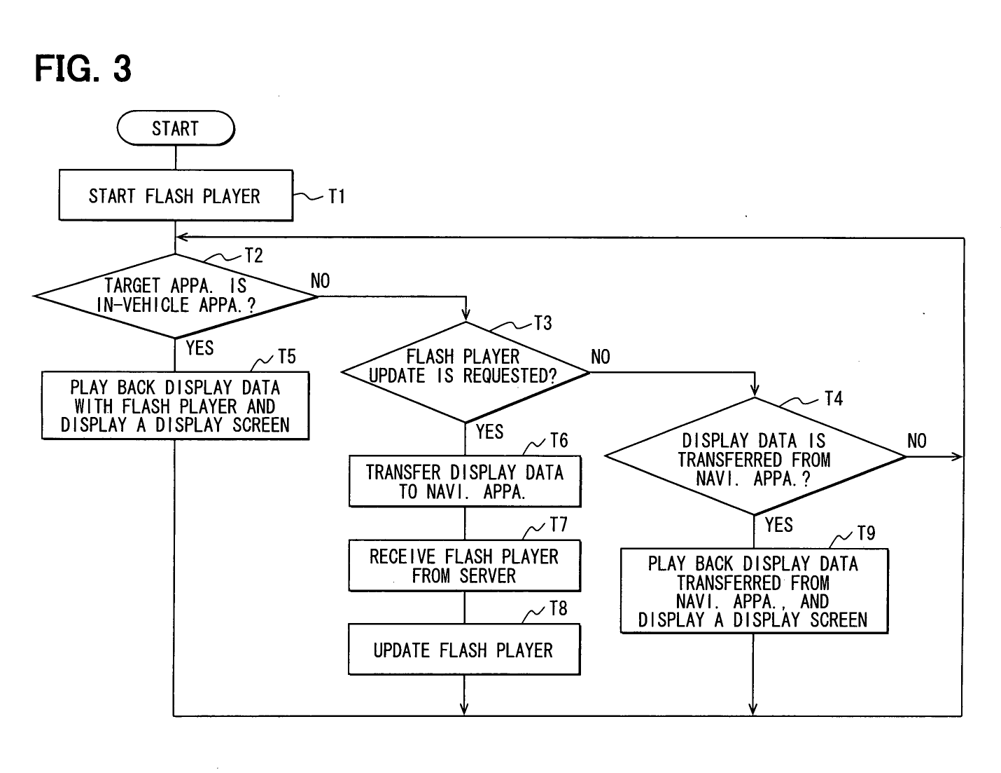

Operation of the in-vehicle system 1 will be described below with reference to FIG. 2 and FIG. 3. FIG. 2 is a flowchart illustrating processes performed by the navigation apparatus 2. FIG. 3 is a flowchart illustrating processes performed by the in-vehicle apparatus 3.

(1) Processes Performed by the Navigation Apparatus 2

When the navigation apparatus 2 is in the powered-on state due to, for example, the ON state of the ACC switch, the navigation apparatus 2 performs the following. At S1, the controller 21 starts the flash player stored in the flash player storage unit 22. At S2, the controller 21 determines whether a display target apparatus is set to the navigation apparatus 2. At S3, the controller 21 determines whether update of the flash player is requested. At S4, the controller 21 determines whether display data is transferred from the in-vehicle apparatus 3 to the navigation apparatus 2.

The display target apparatus may be selectively set to the navigation apparatus 2 or the in-vehicle apparatus 3. For example, in response to user manipulation on the manipulation reception unit 25, the display target apparatus may be switched into the navigation apparatus 2 or the in-vehicle apparatus 3. When a user manipulates the manipulation reception unit 25 to switch the display target apparatus into the navigation apparatus 2 for example, the controller 21 determines that the target display apparatus is set to the navigation apparatus 2, corresponding to “YES” at S2, and the process proceeds to S5. At S5, the controller 21 plays back display data with the flash player stored in the flash player storage unit 22, and causes the display unit 24 to display a display screen that is made by the flash player playing back the display data. After S5, the process returns to S2 to S4. In the above, when the controller 21 determines at S2 that the display target apparatus is set to the navigation apparatus 2, the controller 21 notifies the in-vehicle apparatus 3 via the external interface 23 that the display target apparatus is set to the navigation apparatus 2.

When a user manipulates the manipulation reception unit 25 to instruct the update of the flash player stored in the flash player storage unit 22 of the navigation apparatus 2 for example, the controller 21 determines that the update of the flash player is requested. In this case, the determination “YES” is made at S3, and the process proceeds to S6. At S6, the controller 21 transfers the display data of the navigation apparatus to the in-vehicle apparatus 3 via the external interface 23. At S7, the controller 21 causes the communication unit 36 of the in-vehicle apparatus 3 to receive a flash player (e.g., for update including version up or version down) from the server 6. At S8, the controller 21 (i) causes transfer of the flash player (which the communication unit 36 has received from the server 6) to the external interface 23 of the navigation apparatus 2 via the external interface 33 of the in-vehicle apparatus 3, and (ii) records the transferred flash player in the flash player storage unit 22, and thereby (iii) updates the flash player stored in the flash player storage unit 22 of the navigation apparatus 2. After S8, the process returns to S2 to S4.

When the controller 21 determines that the display data is transferred from the in-vehicle apparatus 3 to the navigation apparatus 2, corresponding to “YES” at S4, the process proceeds to S9. At S9, the controller 21 causes the flash player stored in the flash payer storage unit 22 to play back the display data transferred from the in-vehicle apparatus 3, and causes the display unit 24 to display the display screen that is made by the flash player playing back the display data transferred from the in-vehicle apparatus 3. The processes illustrated in FIG. 2 may be ended when the navigation apparatus 2 is powered-off.

(Processes Performed by in-Vehicle Apparatus 3)

When the in-vehicle apparatus 3 is in the powered-on state due to, for example, the ON state of the ACC switch, the controller 31 can perform the following. At T1, the controller 31 starts the flash player stored in the flash player storage unit 32. At T2, the controller 31 determines whether the display target apparatus is set to the in-vehicle apparatus 3. At T3, the controller 31 determines whether an update of the flash player is requested. At T4, the controller 31 determines whether the display data is transferred from the navigation apparatus 2 to the in-vehicle apparatus 3.

When a user manipulates the manipulation reception unit 34 to switch the display target apparatus into the in-vehicle apparatus 3 for example, the controller 31 determines that the display target apparatus is set to the in-vehicle apparatus 3. In this case, the determination “YES” is made at T2, and the process proceeds to T5. At T5, the controller 31 (i) causes the flash player stored in the flash player storage unit 32 to play back display data, (ii) causes the flash player playing back the display data to make a display screen, transfers the display screen, which is made by the plash player, to the navigation apparatus 2 via the external interface 33 of the in-vehicle apparatus 3, and (iii) causes the display unit 24 to display the transferred display screen. After T5, the process returns to T2 to T4. In the above, when the controller 31 determines at T2 that the display target apparatus is set to the in-vehicle apparatus 3, the controller 31 notifies the navigation apparatus 2 via the external interface 33 that the display target apparatus is set to the in-vehicle apparatus 3.

When a user manipulates the manipulation reception unit 34 to instruct update of the flash player for example, the controller 31 determines that the update of the flash player is requested, corresponding to “YES” at T3. In this case, the process proceeds to T6. At T6, the controller 31 transfers the display data of the in-vehicle apparatus 3 to the navigation apparatus 2 via the external interface 33. At T7, the controller 31 causes the communication unit 36 to receive a flash player from the server 6. At T8, the controller 31 updates the flash player stored in the flash player storage unit 32 by recording, in the flash player storage unit 32, the flash player that the communication unit 36 has received from the server 6. After T8, the process proceeds to T2 to T4.

When the controller 31 determines that the display data is transferred from the navigation apparatus 2 to the in-vehicle apparatus 3, corresponding to “YES” at T4, the process proceeds to T9. At T9, the controller 31 causes the flash player stored in the flash player storage unit 32 to play back the display data transferred from the navigation apparatus 2, causes the flash player playing the display data to make a display screen, transfers the display screen, which is made by the flash player playing the display data transferred from the navigation apparatus 2, to the navigation apparatus 2 via the external interface 33, and causes the display unit 24 to display the transferred display screen. After T9, the process returns to T2 to T4. The processes illustrated in FIG. 3 may be ended when the in-vehicle apparatus 3 is powered-off.

According the present embodiment as described above, the in-vehicle system 1 has the following configuration. The navigation apparatus 2 includes the flash player storage unit 22 storing therein a flash player. The in-vehicle apparatus 3 includes the flash player storage unit 32 storing therein a flash player. The navigation apparatus 2 can perform a process of starting the flash player stored in the flash player storage unit 22, independently of a process of starting, by the in-vehicle apparatus 3, the flash player stored in the flash player storage unit 32. The in-vehicle apparatus 3 can perform the process of starting the flash player stored in the flash player storage unit 32, independently of the process of starting, by the navigation apparatus 2, the flash player stored in the flash player storage unit 22. According to the above configuration, the in-vehicle system 1 can solve various conceivable problems that could arise if the flash player were installed in only the navigation apparatus 2.

More specifically, the in-vehicle system 1 has the following configuration. Display data of the navigation apparatus 2 and that of the in-vehicle apparatus 3 are not played back by the same flash player. The flash player of one of the navigation apparatus 2 and the in-vehicle apparatus 3, the one being determined to be the display target apparatus, plays back display data to make a display screen. The display unit 24 displays the display screen that is made by the flash player playing the display data. The flash player of the navigation apparatus 2 and that of the in-vehicle apparatus 3 are independent of each other. According to the above configuration, even when the display unit 24 is shared by the navigation apparatus 2 and the in-vehicle apparatus 3, it is possible to properly switch display between the navigation apparatus 2 and the in-vehicle apparatus 3.

Moreover, the in-vehicle system 1 has the following configuration. When the update of the flash player of the in-vehicle apparatus 3 is requested, display data is transferred from the in-vehicle apparatus 3 to the navigation apparatus 2, and the flash player stored in the flash player storage unit 32 is updated by recording, in the flash player storage unit 32, a flash player which the communication unit 36 receives from the server 6. The display data transferred from the in-vehicle apparatus 3 to the navigation apparatus 2 is played back by the flash player stored in the flash player storage unit 22 of the navigation apparatus 2. According to the above configuration, while the display data of the in-vehicle apparatus 3 can be played by the flash player installed in the navigation apparatus 2, the flash player installed in the in-vehicle apparatus 3 can be updated. It is therefore possible to improve functions of the in-vehicle system 1 as a whole.

The above advantage will be more specifically described. When a flash player is improved (what is called version-up) in response to, for example, function addition, bug fix and the like, it is common to update the flash player. However, in the case of a navigation apparatus, operating stability of navigation functions (e.g., route retrieval, rout guidance etc.) is typically put ahead of the update of a flash player, and thus, a user tends to hesitate the update of a flash player. In the in-vehicle system 1 of the present embodiment, the flash player installed in the in-vehicle apparatus 3 can be updated without the update of the flash player installed in the navigation apparatus 2. Therefore, while operation of the navigation apparatus 2 is being stabilized, it is possible to enhance functions of the in-vehicle system 1 as a whole.

In the reverse situation where the update of the flash player of the navigation apparatus 2 is requested, the display data is transferred from the navigation apparatus 2 to the in-vehicle apparatus 3, and the flash player stored in the flash player storage unit 22 is updated by recording, in the flash player storage unit 22, a flash player which the communication unit 36 receives from the server 6. The display data transferred from the navigation apparatus 2 to the in-vehicle apparatus 3 is played back by the flash player stored in the flash player storage unit 32. Therefore, while the display data of the navigation apparatus 2 can be played by the flash player installed in the in-vehicle apparatus 3, the flash player installed in the navigation apparatus 2 can be updated. Thereby, it is possible to improve functions of the in-vehicle system 1 as a whole.

The above embodiment can be modified and extended in various ways. For example, although the communication unit for receiving a flash player from a server is equipped in the in-vehicle apparatus in the above embodiment, the communication unit may be equipped in the navigation apparatus.

In the above embodiment, the controller 21 of the navigation apparatus 2 can act as a first controller, first control means, or navigation apparatus side control means. The flash player storage unit 22 can act as a first storage unit, first storage means, or navigation apparatus side storage means. The display device 24 can act as display means. The controller 31 of the in-vehicle apparatus 3 can act as a second controller, second control means, or in-vehicle apparatus side control means. The flash player storage unit 32 can act as second storage unit, second storage means, or in-vehicle apparatus side storage means. The communication unit 36 can act as a flash player acquisition unit or flash player acquisition means.

According to an aspect of the present disclosure, an in-vehicle system is provided. The in-vehicle system includes a display unit, a navigation apparatus, and a in-vehicle apparatus. The navigation apparatus includes: a first storage unit storing therein a first flash player; and a first controller configured to (i) start the first flash player stored in the first storage unit, (ii) cause the first flash player to play back first display data, and (iii) cause the display unit to display a display screen that is made by the first flash player playing back the first display data. The in-vehicle apparatus is provided separately from the navigation apparatus, and includes: a second storage unit storing therein a second flash player; and a second controller configured to (i) start the second flash player stored in the second storage unit, (ii) cause the second flash player to play back second display data, and (iii) cause the display unit to display a display screen that is made by the second flash player playing back the second display data. The first controller and the second controller are further configured to be operable such that: the first controller performs a process of starting the first flash player independently of a process of starting the second flash player by the second controller; and the second controller performs the process of starting the second flash player independently of the process of starting the first flash player by the first controller.

According to the above in-vehicle system, the flash player is installed in not only the navigation apparatus. The flash players are respectively installed in both of the navigation apparatus and the in-vehicle apparatus. Therefore, the in-vehicle system can solve the various conceivable difficulties that could arise if the flash player were installed in only the navigation apparatus.

The above in-vehicle system may be configured in the following way. When a display target apparatus is set to the navigation apparatus, the first controller of the navigation apparatus allows the display unit to display the display screen that is made by the first flash player playing back the first display data. When the display target apparatus is set to the in-vehicle apparatus, the second controller of the in-vehicle apparatus allows the display unit to display the display screen that is made by the second flash player playing back the second display data.

According to the above configuration, the first display data of the navigation apparatus and the second display data of the in-vehicle apparatus are played back not using the same flash player, but can be respectively played back using the first flash player of the navigation apparatus and the second flash player of the in-vehicle apparatus. The first flash player of the navigation apparatus and the second flash player of the in-vehicle apparatus are independent of each other. One of the navigation apparatus and the in-vehicle apparatus, the one being determined to be the display target apparatus, plays back the display data with the flash player of the target apparatus and causes the display unit to display the display screen that is made by the flash player of the target apparatus. Therefore, even when the navigation apparatus and the in-vehicle apparatus are configured to share the display unit, it is possible to properly switch display between the navigation apparatus and the in-vehicle apparatus.

The above in-vehicle system may further include a flash player acquisition unit configured to acquire an update flash player from an outside of the in-vehicle system. When update of the second flash player stored in the second storage unit is requested, the second controller may transfers the second display data from the in-vehicle apparatus to the navigation apparatus and may update the second flash player by recording the update flash player, which is acquired by the flash player acquisition unit, in the second storage unit. When the second display data is transferred from the in-vehicle apparatus to the navigation apparatus, the first controller may cause the first flash player to play back the transferred second display data and may cause the display unit to display a display screen that is made by the first flash player playing back the transferred second display data.

According to the above configuration, when the flash player installed in the in-vehicle apparatus is updated, the display data of the in-vehicle apparatus is transferred to the navigation apparatus. Thus, while the display data transferred from the in-vehicle apparatus can be played back by the flash player installed in the navigation apparatus, the flash player installed in the in-vehicle apparatus can be updated. Functions of the in-vehicle system can be therefore enhanced.

The above in-vehicle system may be configured such that: when update of the first flash player stored in the first storage unit is requested, the first controller transfers the first display data from the navigation apparatus to the in-vehicle apparatus and updates the first flash player by recording the update flash player, which is acquired by the flash player acquisition unit, in the first storage unit; and when the first display data is transferred from the navigation apparatus to the in-vehicle apparatus, the second controller causes the second flash player to play back the transferred first display data and causes the display unit to display a display screen that is made by the second flash player playing the transferred first display data.

According to the above configuration, when the flash player installed in the navigation apparatus is updated, the display data of the navigation apparatus is transferred to the in-vehicle apparatus. Thus, while the display data transferred from the navigation apparatus can be played back by the flash player installed in the in-vehicle apparatus, the flash player installed in the navigation apparatus can be updated. Functions of the in-vehicle system can be therefore enhanced.

While the invention has been described above with reference to various embodiments thereof, it is to be understood that the invention is not limited to the above described embodiments and constructions. The invention is intended to cover various modifications and equivalent arrangements.

Further, each or any combination of procedures, processes, steps, or means explained in the above may be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units may be included in a software program, which is contained in a computer-readable storage media or is installed in a computer via a communications network.

What is claimed is:

1. An in-vehicle system comprising:
a display unit;
a navigation apparatus that includes
a first storage unit storing therein a first flash player and
a first controller configured to (i) start the first flash player stored in the first storage unit, (ii) cause the first flash player to play back first display data, and (iii) cause the display unit to display a display screen that is made by the first flash player playing back the first display data; and
an in-vehicle apparatus that is provided separately from the navigation apparatus, and that includes
a second storage unit storing therein a second flash player and
a second controller configured to (i) start the second flash player stored in the second storage unit, (ii) cause the second flash player to play back second display data, and (iii) cause the display unit to display a display screen that is made by the second flash player playing back the second display data,
wherein the first controller and the second controller are further configured to be operable such that:
the first controller performs a process of starting the first flash player independently of a process of starting the second flash player by the second controller; and
the second controller performs the process of starting the second flash player independently of the process of starting the first flash player by the first controller.

2. The in-vehicle system according to claim 1, wherein:
when a display target apparatus is set to the navigation apparatus, the first controller of the navigation apparatus allows the display unit to display the display screen that is made by the first flash player playing back the first display data; and
when the display target apparatus is set to the in-vehicle apparatus, the second controller of the in-vehicle apparatus allows the display unit to display the display screen that is made by the second flash player playing back the second display data.

3. The in-vehicle system according to claim 1, further comprising:
a flash player acquisition unit configured to acquire an update flash player from an outside of the in-vehicle system,
wherein:
when update of the second flash player stored in the second storage unit is requested, the second controller transfers the second display data from the in-vehicle apparatus to the navigation apparatus and updates the second flash player by recording the update flash player, which is acquired by the flash player acquisition unit, in the second storage unit; and
when the second display data is transferred from the in-vehicle apparatus to the navigation apparatus, the first controller causes the first flash player to play back the transferred second display data and causes the display unit to display a display screen that is made by the first flash player playing back the transferred second display data.

4. The in-vehicle system according to claim 1, further comprising:
a flash player acquisition unit configured to acquire an update flash player from an outside of the in-vehicle system,
wherein:
when update of the first flash player stored in the first storage unit is requested, the first controller transfers the first display data from the navigation apparatus to the in-vehicle apparatus and updates the first flash player by recording the update flash player, which is acquired by the flash player acquisition unit, in the first storage unit; and
when the first display data is transferred from the navigation apparatus to the in-vehicle apparatus, the second controller causes the second flash player to play back the transferred first display data and causes the display unit to display a display screen that is made by the second flash player playing the transferred first display data.
